(19) United States
(12) Patent Application Publication
(10) Pub. No.: US 2025/0207855 A1
(43) Pub. Date: Jun. 26, 2025

(54) DRIER

(71) Applicant: MARINI S.P.A., Alfonsine Ravenna (IT)

(72) Inventor: Andrea PIRAZZINI, Cotignola Ravenna (IT)

(21) Appl. No.: 18/957,192

(22) Filed: Nov. 22, 2024

(30) Foreign Application Priority Data
Dec. 20, 2023 (IT) 102023000027357

(51) Int. Cl. F26B 11/02; F26B 21/00

(52) U.S. Cl. CPC F26B 11/028; F26B 11/026; F26B 21/001

(57) ABSTRACT

Described is a drier for industrial plants for the production of bituminous macadams comprising a drying drum (2) rotating about its own main axis of extension (R2), a loading head (3) at a first end (2a) of the drying drum for introducing a virgin inert lithic material into the drying drum, an unloading head (4) at a second end (2b) of the drying drum, a burner (8) for generating a flame (9) in a combustion chamber (7) and a first drying flow (F9) in a drying chamber (6), a feed device (11), positioned downstream of the combustion chamber (7) and upstream of the unloading head (4) for introducing a recycled bituminous material into the drying drum (2); the drying drum (2) comprises a drying chamber (12) downstream of the feed device (11) and upstream of the unloading head (4) and a combustion chamber (13) downstream of the drying chamber (12) and upstream of the unloading head (4) and the drier comprises a system for generating a second flow (F15) of drying gas in the second drying chamber (12).

### DESCRIPTION

This application claims priority to Italian Patent Application 102023000027357 filed Dec. 20, 2023, the entirety of which is incorporated by reference herein.

This invention relates to a drier for industrial plants for the production of mixtures in the form of macadams with bituminous and non-bituminous binders, also called bituminous macadams, designed in particular for making road surfaces.

In the sector of industrial plants for the production of bituminous macadams there are widespread plants which allow the use, in the mixtures, of virgin inert lithic materials, such as, for example, gravel, hereinafter also simply referred to as virgin material, and recycled or regenerated material (Recycled Asphalt Pavement RAP) derived, for example, from milling existing road pavements.

Both the virgin materials and the recycled materials must be in predetermined physical conditions in order to be mixed (for example, with high temperature and dried) so they are also processed thermodynamically in the plants of interest.

All the materials are then processed in suitable driers, for example to condition the humidity and inserted in hoppers from which they are picked up to make up the desired final mixture.

Patent document EP3221517, in the name of the same Applicant as this invention, illustrates a plant for the production and distribution of bituminous macadams comprising a counter-current drier (the material to be dried moves inside the drum in the direction opposite to the flow of hot drying air) provided with a single burner for drying the materials to be processed, both virgin and recycled.

The drier comprises, schematically, the burner and a rotary drum inside of which the flame generated by the burner leads, thus identifying a combustion chamber.

The drum is provided with an inlet opening for the virgin material and a feed device, positioned downstream of the combustion chamber in the feed direction of the virgin material, for the introduction of any recycled macadams.

An unloading head, located at an end of the drum opposite the infeed opening for virgin material, allows the outfeed of virgin and recycled materials once processed.

The introduction of the recycled macadams into a feed position located after the combustion chamber, in particular downstream of the burner flame, according to the feed direction of the material in the drier, is necessary since excessive heating, due to the flame, of the recycled macadams containing bitumen would result in significant pollutant emissions.

Feeding the recycled materials downstream of the combustion chamber avoids the exposure of the recycled macadams containing bitumen to the flame of the burner, also preventing the occurrence of further emissions of pollutant compounds.

The main drawback of this prior art solution is that recycled materials can be introduced into the drier of up to 35-40% of the total of the material processed.

In effect, the recycled materials, as they are not heated for the reasons mentioned above, reduce the temperature of the virgin materials with which they are mixed, before the unloading head, thus reducing the temperature of the mixture flowing out of the drier.

Since the temperature of the mixture at the outfeed must be at 160°, the feeding of an excessive quantity of recycled material would not allow this condition to be met whilst the main need in the sector is to use increasingly greater percentages of recycled material and, at the same time, reduce the emissions of pollutant compounds.

In this context, the aim is to propose a drier that is capable of overcoming at least some of the drawbacks of the prior art and of meeting the above-mentioned need.

In particular, the aim of this invention is to provide a drier which allows an increase in the percentage of recycled material in the mix, containing the pollutant emissions.

This aim is achieved by a drier comprising the technical features described in one or more of the accompanying claims. The dependent claims correspond to possible different embodiments of the invention.

According to a first aspect, this invention relates to a drier for industrial plants for the production of bituminous macadams.

The drier, described only insofar as necessary for understanding this invention, comprises a drying drum which rotates about its own main axis of extension.

The drier comprises a loading head at a first end of the drying drum, for introducing a first material into the drying drum.

Preferably, the first material is a virgin inert lithic material.

The drier comprises an unloading head at a second end of the drying drum.

The drier comprises a feed system for feeding, in a feed direction, the first material from the loading head to the unloading head.

The drying drum comprises a first drying chamber and a first combustion chamber downstream of the first drying chamber according to the feed direction of the first material.

The drier comprises a first burner positioned at the second end to generate a first flame in the first combustion chamber and a first drying flow in the first drying chamber.

The first burner comprises a feed duct for feeding a fuel to the first flame in the first combustion chamber.

Preferably, the first burner has a power of between 9 MW and 30 MW.

The first drying flow moves in the opposite direction to the feed direction of the first material and the drier is therefore a drier of the counter-current type.

The drier comprises a feed device, positioned downstream of the first combustion chamber and upstream of the unloading head in said feed direction, for introducing a second material into the drying drum; the second material is preferably a recycled bituminous material.

The feed system is configured for feeding a mixture of the first material and the second material, in particular a mixture of virgin inert lithic material and recycled bituminous material, downstream of the feed device up to the unloading head.

The feed direction is the same for the first and the second material downstream of the feed device.

The drying drum comprises a second drying chamber downstream of the feed system and upstream of the unloading head according to the feed direction of the first and of the second material.

Preferably, the duct for feeding the first burner passes through the second drying chamber, for feeding a fuel to the first flame in the first combustion chamber.

The drier comprises a system for generating a flow of drying gas, comprising, for example, hot air, for generating a second flow of drying gas in the second drying chamber.

The second flow of drying gas moves in the opposite direction to the feed direction of the first material and flows in counter-current with respect to the mixture of the first and second materials.

The second flow of drying gas has a temperature which is less than the temperature of the first flow of drying gas.

The system for generating the second drying flow may comprise a second combustion chamber in the drying drum.

The second combustion chamber is positioned downstream of the second drying chamber and upstream of the unloading head according to the feed direction of the first and of the second material.

The drier comprises at least a second burner having a power less than that of the first burner for generating a second flame in the second combustion chamber and the second flow of drying gas at least in the second drying chamber.

Preferably, the second burner has a power of between 0.5 MW and 4 MW.

Preferably, the second burner is located at the second end of the drying drum.

Preferably, the drier comprises a third burner which generates a third flame in the second combustion chamber. The second and the third flame combined determine the second flow of drying gas.

Preferably, the second and the third burner have a same power.

Preferably, the third burner is located at the second end of the drying drum.

Preferably, the duct for feeding the first burner passes through the second combustion chamber and the second drying chamber, for feeding a fuel to the first flame in the first combustion chamber.

Preferably, the drier comprises a tubular protection for the feed duct.

Preferably, the feed duct passes through said tubular protection, that is to say, it is inserted in it.

Preferably, the tubular protection extends through the second combustion chamber and the second drying chamber.

Preferably, the tubular protection is fixed to the drying drum and rotates with it.

The system for generating the second flow of drying gas may comprise a hot air generator, of substantially known type, in communication with the second drying chamber for generating hot air and feeding into it the second flow of drying gas.

Preferably, the hot air generator is positioned outside the drying drum, preferably connected to the unloading head.

Preferably, the system for feeding the material into the drying drum comprises a comb-type blading, fixed to an inner surface of the drying drum at the second drying chamber.

Preferably, the feed system comprises a plurality of tiles for protecting the base of the drier in order to protect it from wear due to rubbing, at the second combustion chamber.

Advantageously, the protective tiles, avoiding the lifting of the material (which therefore feeds forward sliding on the bottom), prevent the mixture of the first and the second material from being affected by the second flame and/or by the third flame so that the recycled bituminous material does not release pollutant emissions due to the combustion of the bitumen.

Preferably, the ratio between a total length of the first drying chamber and of the first combustion chamber measured according to the main axis of extension of the drying drum and a total length of the second drying chamber and of the second combustion chamber measured according to the main axis of extension of the drying drum is between 1.5 and 2.5.

Preferably, the ratio between a length of the second drying chamber measured according to the main axis of extension of the drying drum and a length of the second combustion chamber measured according to the main axis of extension of the drying drum is between 1 and 4.

In practice, compared with a traditional drier, the drier according to this invention is elongate downstream of the feed device since the drum comprises the second drying chamber and, if necessary, the second combustion chamber, before the unloading head, thanks to which it is possible to further dry the mixture of virgin materials and RAP, heating it with the second drying flow.

According to an aspect, the invention relates to a method for drying a virgin inert lithic material and a recycled bituminous material.

The method comprises introducing the virgin inert lithic material into a drier, heating the virgin inert lithic material with a first flow of drying gas having a first temperature and generated by a first flame, mixing the heated virgin inert lithic material with the recycled bituminous material obtaining a mixture, heating the mixture with a second flow of drying gas having a second temperature less than the first temperature, unloading the mixture heated by the drier.

The second flow of drying gas can be generated by a second flame inside the drier.

The second flow of drying gas may be generated by a hot air generator outside the drier and introduced in the drier.

Preferably, the drier is a drier for industrial plants of bituminous macadams according to a previous aspect.

The drier according to the above aspects brings important advantages.

The second drying chamber, located downstream of the device for feeding the recycled bituminous material, allows the temperature of the mixture to be raised.

Compared with a traditional drier, for example that described in patent document EP3221517, with the same temperature of the mixture and that reached by the virgin material, it is possible to add a greater quantity of recycled bituminous material to the virgin lithic material since the mixture, which has undergone a greater lowering of the temperature, is subsequently heated in the second drying chamber before the unloading.

The Applicant has observed that with the drier according to the invention it is possible to reach percentages of RAP of up to 60% by weight of the mixture.

In the same way, it is possible to heat less the virgin materials due to the subsequent heating of the mixture.

The second flow of drying gas has a reduced temperature compared with the first flow of drying gas in such a way as to limit the increase in the temperature of the RAP so as not to generate pollutant compounds but sufficient to bring the temperature of the mixture to the desired values at the outfeed, which are necessary for the subsequent processing in the plants for the production of bituminous macadams.

Advantageously, the gases generated in the second combustion chamber, when provided, are conveyed into the first combustion chamber having the characteristics for thermally processing any pollutant compounds, as described, for example, in patent document EP3221517. The Applicant has observed that with the drier according to the invention it is possible to contain the pollutant emissions below 50 mg/Nm3 VOC.

Advantageously, the fumes exiting the drier according to this invention have a lower temperature than that of the prior art solutions.

The drier according to the invention allows a reduction in the emissions of pollutant compounds compared with prior art driers.

Advantageously, the drier according to this invention allows a better distribution of the heat inside the drier, increasing the efficiency.

Advantageously, the drier according to the invention also allows a reduction in the odours released at the outlet, heating the RAP in a more gradual fashion by conduction and by convection.

Further features and advantages of the above-mentioned aspects are more apparent in the non-limiting description which follows of a preferred, non-limiting embodiment of a drier for industrial plants for the production of bituminous macadams.

The description is set out below with reference to the accompanying drawings which are provided solely for purposes of illustration without restricting the scope of the invention and in which:

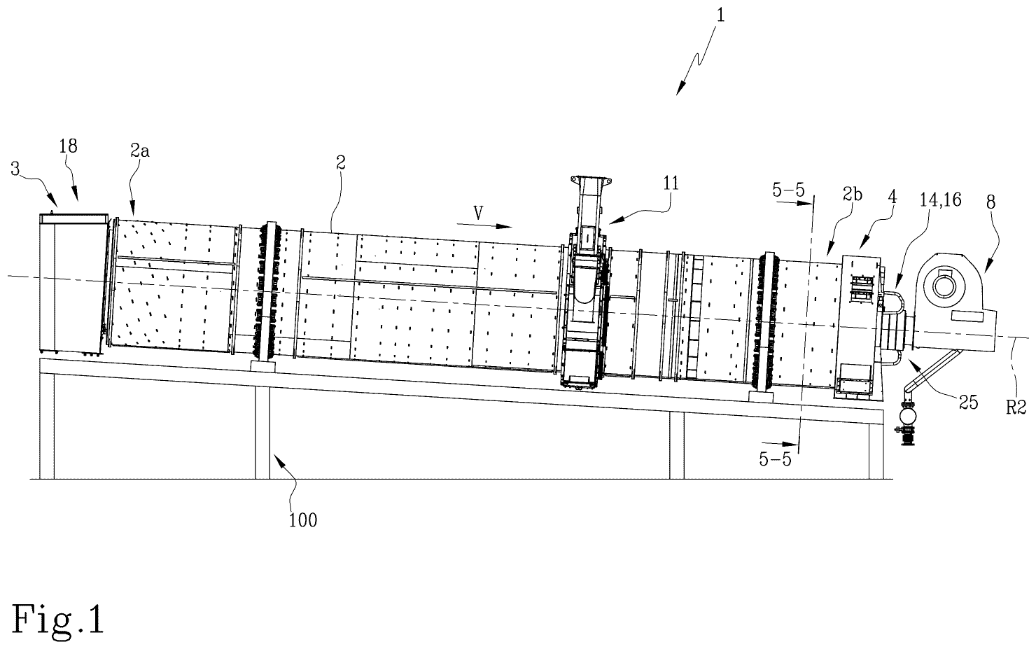

FIG. 1 is a schematic side view of a drier according to the invention;

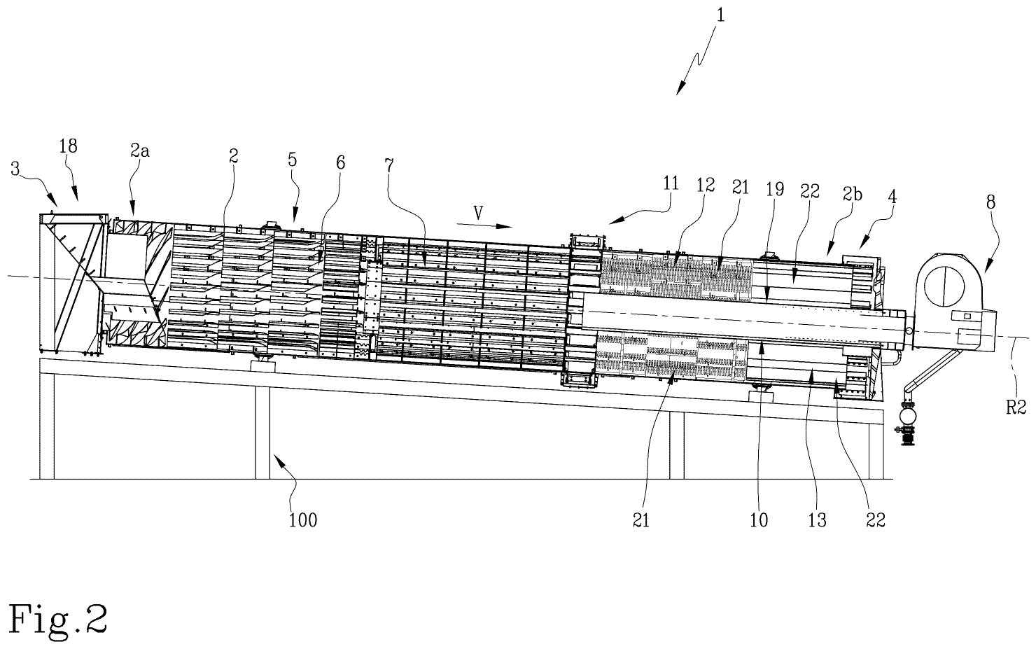

FIG. 2 illustrates a schematic section view, with some parts removed for better clarity, of the drier of FIG. 1;

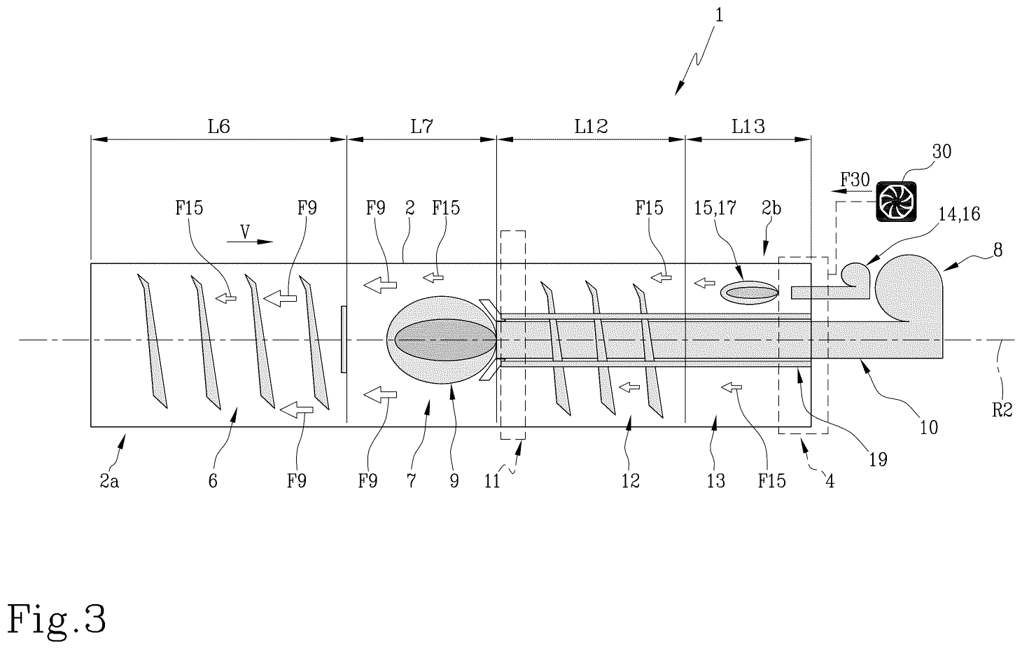

FIG. 3 illustrates a side view, with some parts cut away for better clarity, of the drier of FIGS. 1 and 2;

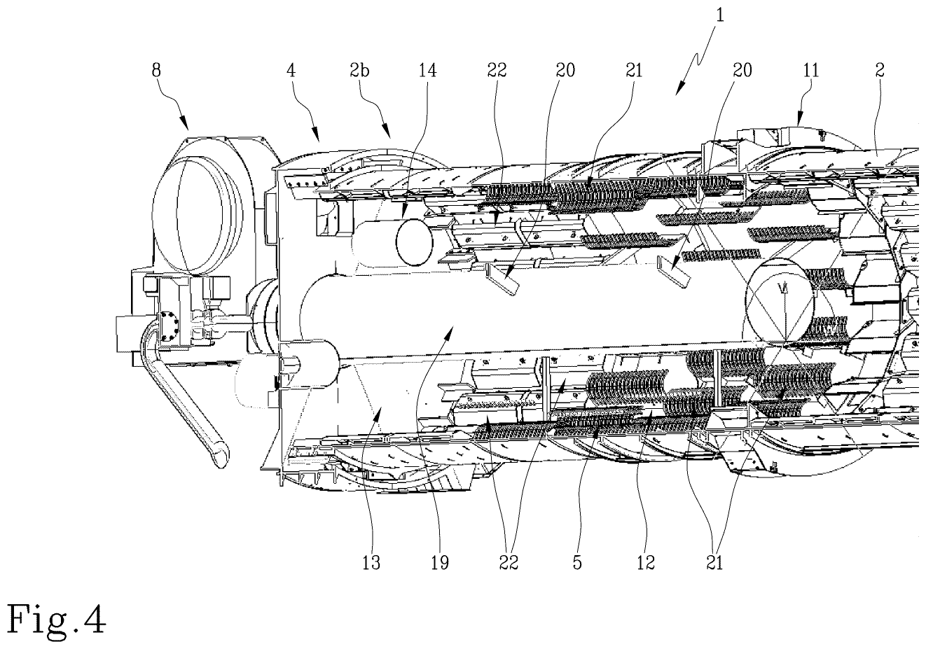

FIG. 4 illustrates a schematic cross section perspective view of a detail of the drier of FIG. 1;

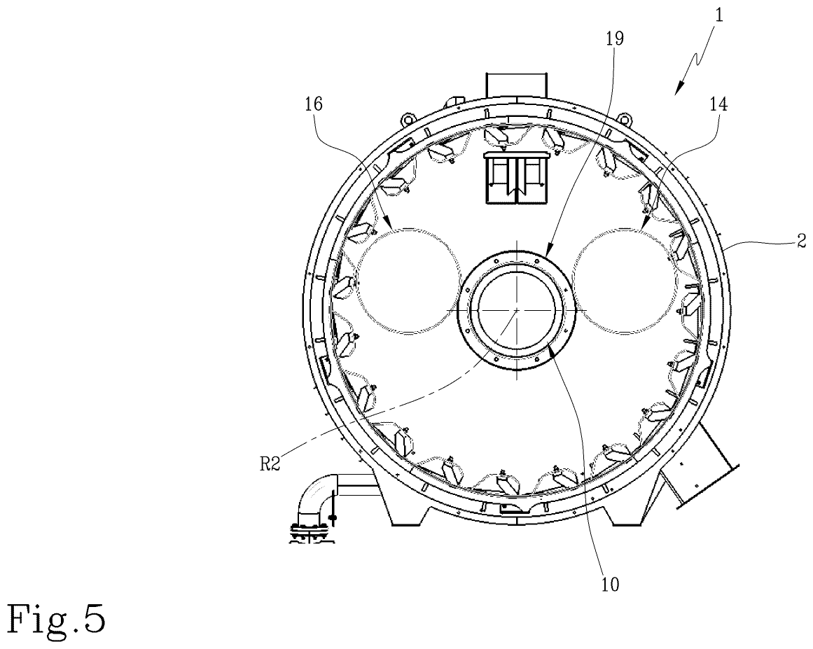

FIG. 5 illustrates a schematic cross section view of the drier of FIG. 1 through the plane 5-5 of FIG. 1;

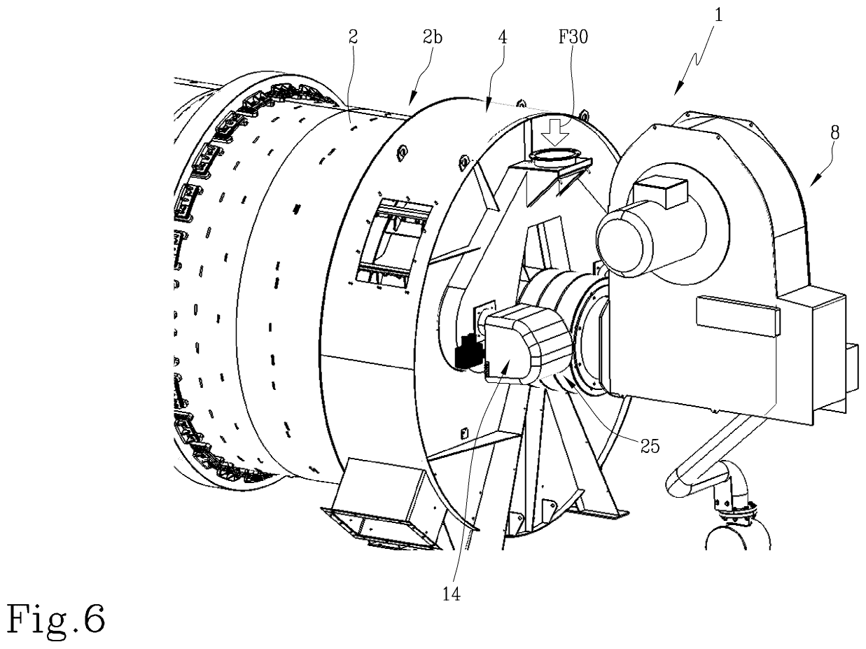

FIG. 6 illustrates a detail of the drier of FIG. 1 in a schematic perspective view;

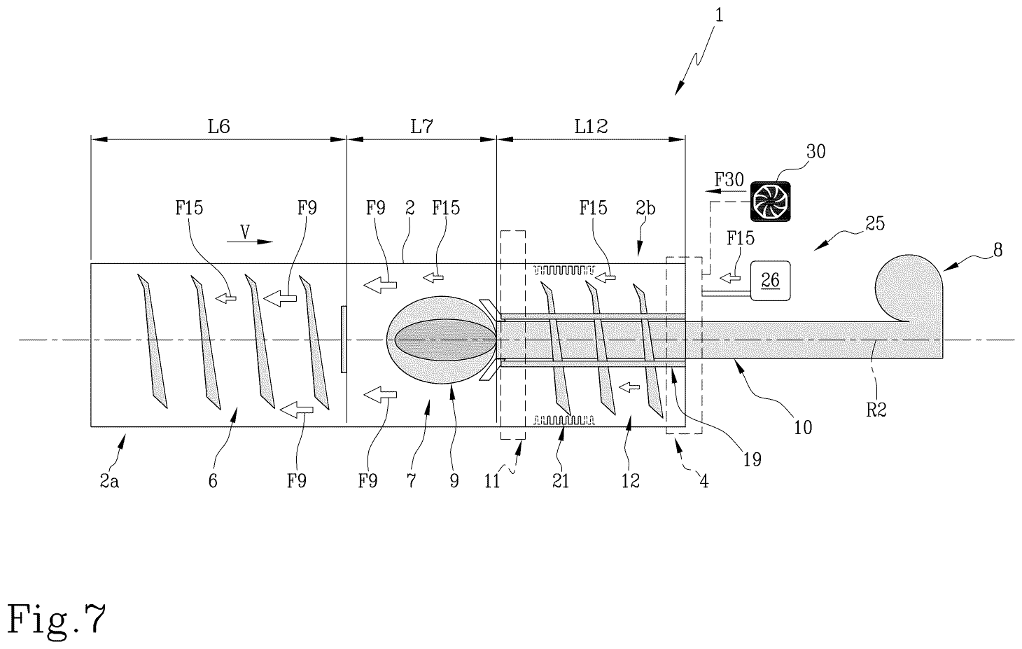

FIG. 7 illustrates a schematic side view, with some parts cut away for greater clarity, of a drier according to the invention.

With reference to the accompanying drawings, the numeral 1 denotes in its entirety drier according to this invention.

The drier 1 is designed for an industrial plant, not illustrated, for the production of bituminous macadams.

Schematically, as described in more detail below, the drier 1 is in particular designed for conditioning a mixture of virgin inert lithic materials, such as, for example gravel, and recycled or regenerated material (Recycled Asphalt Pavement, RAP) derived, for example, from milling of existing road pavements.

FIGS. 1 and 2 also schematically illustrate a frame 100 for supporting the drier 1.

The drier 1 comprises a drying drum 2 rotating about its own main axis of extension R2.

The drier comprises a loading head 3 at a first end 2a of the drying drum 2.

The loading head 3 is used for introducing, in the drying drum 2, a first material, preferably a virgin inert lithic material.

The drier 1 comprises un unloading head 4 at a second end 2b of the drying drum 2 from which the mixture of virgin inert lithic materials and RAP may be unloaded.

The drier 1 comprises a feed or transport system 5 for feeding, in a feed direction V, the material from the loading head 3 to the unloading head 4.

The feed system 5 is schematically based on the rotation of the drying drum 2, on its inclination, as can be seen in FIGS. 1 and 2 where there is a slope between the loading head 3 and the unloading head 4, and on a particular apparatus provided in the inner surface of the drum 2.

Schematically, the geometry of the equipment, the inclination and the speed of rotation of the drum determine the time of travel of the material from the loading head 3 to the unloading head 4.

The drying drum 2 comprises a first drying chamber 6 and a first combustion chamber 7 downstream of the first drying chamber 6 according to the feed direction V of the first material.

The drier 1 comprises a first burner 8, of substantially known type, positioned at the second end 2b of the drying drum 2 for generating a first flame 9 in the first combustion chamber 7 and a first flow F9 of drying gas, that is, hot air, in the first drying chamber 6.

The first burner 8 comprises a feed duct 10 for feeding a fuel to the first flame 9 in the first combustion chamber 7.

The feed duct 10 projects from the head 4 to the first combustion chamber 7 inside the drying drum 2.

Preferably, the first burner 8 has a power of between 9 MW and 30 MW.

The drier 1 comprises a feed device 11, positioned downstream of the first combustion chamber 7 and upstream of the unloading head 4 along said feed direction V.

The feed device 11 is provided and configured for introducing into the drying drum 2 a second material, preferably a recycled bituminous material.

The feed system 5 is configured for feeding the above-mentioned mixture of virgin inert lithic material and RAP which is comprised, inside the drying drum 2, downstream of the feed device 11, up to the unloading head 4.

In practice, the system and the feed direction V are common for the first and for the second material downstream of the feed device 11.

The drying drum 2 comprises a second drying chamber 12 downstream of the feed system 11 and upstream of the unloading head 4 in the feed direction V of the mixture of the first and of the second material.

The drier comprises a system for generating a flow of drying gas, of substantially known type, denoted in its entirety by the numeral 25.

The system 25 is configured to generate a second flow of drying gas F15, that is, hot air, in the second drying chamber 12.

According to an embodiment illustrated in FIGS. 1 to 6, the system 25 comprises a second combustion chamber 13 in the drying drum 2.

The second combustion chamber 13 is located downstream of the second drying chamber 12 and upstream of the unloading head 4 according to the feed direction V of the mixture of the first and of the second material.

According to the embodiment illustrated, the total length L6+L7, measured along the axis R2, of the first drying chamber 6 and of the first combustion chamber 7 is equal to 10 m, the second drying chamber 12 has a length L12, measured along the axis R2, of 3.5 m and the second combustion chamber 13 has a length L13, measured along the axis R2, equal to 2 m.

Preferably, the ratio between the total length L6+L7, measured according to the axis R2, of the first drying chamber 6 and of the first combustion chamber 7 and the total length L12+L13 of the second drying chamber 12 and of the second combustion chamber 13 is between 1.5 and 2.5.

Preferably, the ratio between a length L12 of the second drying chamber 12 and the length L13 of the second combustion chamber 13 is between 1 and 4.

The drier 1 comprises at least a second burner 14 having a power less than that of the first burner 8 to generate a second flame 15 in the second combustion chamber 13 and the second flow F15 of drying gas at least in the second drying chamber 12.

Preferably, the second burner 14 has a power of between 0.5 MW and 4 MW.

According to the embodiment illustrated, the second burner is positioned substantially at the second end 2b of the drying drum 2.

Preferably, the drier comprises a third burner 16 generating a third flame 17 in the second combustion chamber. The second and the third flames 15, 17 combined determine the second flow F15 of drying gas.

In general, the drier according to the invention can comprise any number of burners in the second combustion chamber 13 on the basis of the design requirements, in particular as a function of the expected second flow F15 of drying gas.

Preferably, the third burner 16 has the same power as the second burner 14. Preferably, the third burner 16 is located at the second end 2b of the drying drum.

According to an example embodiment, illustrated in FIG. 5, the second and third burners 14, 16 are arranged symmetrically relative to a vertical plane, with reference to the drawing, passing through the axis R2 to obtain a drying flow F15 which is as uniform as possible in the second drying chamber 12.

Generally speaking, the second and third burners 14, 16 are located preferably so as not to interact with the material present in the drum 2.

According to preferred embodiments not illustrated, the second and the third burner 14, 16 are located on a plane inclined relative to the vertical plane.

According to preferred embodiments not illustrated, the second and the third burner 14, 16 are located asymmetrically in the drying drum 2. The second and the third burner 14, 16, are located in the drier 1 as a function of the space available for the installation.

According to the embodiment schematically illustrated in FIG. 7, the system 25 for generating the second flow F15 of drying gas comprises a hot air generator 26, of substantially known type.

The hot air generator 26 is in communication with the second drying chamber 12 for feeding in it the second flow F15 of drying gas.

The hot air generator 26 is positioned outside the drying drum 2 and is connected to the unloading head 4.

According to alternative embodiments not illustrated, the hot air generator 26 may be separate from the drying drum 2.

The drier 1 comprises a ventilation system for inserting air coming from a mixing plant normally provided in the industrial plant for the production of bituminous macadams into the drier 1, in particular into the drying drum 2. The drier 1 is kept at a negative pressure, in known manner, by the dust separator filter which is also normally provided in the industrial plant for the production of bituminous macadams.

The ventilation system comprises a fan, schematically represented as a block 30 in FIG. 3, for generating a flow F30.

According to the preferred embodiment illustrated, the flow F30 is between 2000 m3/h and 6000 m3/h.

The drier 1 comprises a system, of substantially known type and labelled 18, for evacuating fumes, also comprising at least one filter and a flue, not illustrated. The flows F15 and F9 of drying gas combine in the chambers 6 and 7 and reach the evacuation system 18.

As illustrated, the duct 10 for feeding the first burner 8 passes through the second drying chamber 12 and, if necessary, the second combustion chamber 13, if present.

The drier 1 comprises a tubular protection 19 for the feed duct 10. Preferably, the tubular protection 19 is coaxial with the drying drum 2.

According to the embodiment illustrated, the tubular protection 19 is fixed, for example by arms 20, to the drying drum 2 and rotates with it.

The tubular protection 19 is inserted in the second drying chamber 12 and in the second combustion chamber 13 passing through them.

The feed duct 10 is inserted in the tubular protection 19 passing through it.

The tubular protection 19 protects the feed duct 10 from the mixture of virgin and RAP materials, which are movable inside the drying drum 2 at least in the second drying chamber 12.

According to the embodiment shown in FIGS. 1 to 6, the tubular protection 19, in the second combustion chamber 13, protects the feed duct 10 both from the mixture of virgin and RAP materials, movable inside the drying drum 2 and from the second and third flames 15, 17.

The above-mentioned system 5 for feeding the materials is described below in more detail solely with regard to the part relating to the second drying chamber 12 and the second combustion chamber 13, that is to say, in the part for feeding the mixture of virgin and RAP materials.

The feed system 5 comprises a comb-type blade unit 21 fixed to an inner surface of the drying drum 2 at the second drying chamber 12.

The blade unit 21 causes the mixture to rain through the drying flow F15 corresponding to a heat exchange of fumes/materials thanks to which the temperature of the mixture is raised before being unloaded.

In the presence of the second combustion chamber 13, the feed system 5 comprises a plurality of tiles 22 for protecting the base of the drier 1 at the second combustion chamber 13.

The tiles 22 are configured to prevent the lifting of the material which therefore advances sliding on the bottom of the drying drum 2, with reference, for example, to FIG. 2.

In this way, the mixture of the first and of the second material avoids the second flame 15 and/or the third flame 17 so that the recycled bituminous material does not release pollutant emissions due to the combustion of the bitumen.

The invention relates to method for drying a virgin inert lithic material and a recycled bituminous material.

The drying method is preferably carried out in a drier of the type of drier 1 described above and reference is made below to the drier 1 without thereby limiting the scope of the invention.

The method comprises introducing the virgin inert lithic material in the drier 1, heating the virgin inert lithic material at least with the first flow F9 of drying gas generated by the first flame 9.

The method comprises mixing the heated virgin inert lithic material with the recycled bituminous material, obtaining a mixture and heating the mixture with a second flow F15 of drying gas.

The virgin inert lithic material is struck by the first and by the second flow of drying gas F9, F15.

The method comprises generating the second flow of drying gas in the second drying chamber.

The second flow of drying gas may be generated by the second flame 15 and by the third flame 17 or by the hot air generator 26.

Advantageously, the second flow F15 of drying gas has a second temperature which is less than the first temperature of the first flow F9 of drying gas.

The method comprises unloading the heated and dried mixture into the drier 1 from the first and from the second flows of drying gas F9 and F15.

1. A drier for industrial plants for the production of bituminous macadams, said drier comprising a drying drum rotating about its own main axis of extension;
a loading head at a first end of the drying drum, for introducing a virgin inert lithic material into the drying drum;
an unloading head at a second end of the drying drum;
a system for feeding virgin inert lithic material in a feed direction from said loading head to said unloading head;
said drying drum comprising a first drying chamber and a first combustion chamber downstream of the first drying chamber according to the feed direction,
said drier comprising a first burner positioned at said second end for generating a first flame in said first combustion chamber and a first drying flow in said first drying chamber;
a feed device, positioned downstream of the first combustion chamber and upstream of the unloading head in said feed direction, for introducing a recycled bituminous material into the drying drum, said feed system being configured for feeding a mixture of the virgin inert lithic material and of the recycled bituminous material downstream of the feed device;
said drying drum comprising a second drying chamber downstream of the feed device and upstream of the unloading head in said feed direction, the drier comprising a system for generating a flow of drying gas for generating a second flow of drying gas at least in said second drying chamber.

2. The drier according to claim 1, wherein the system for generating a flow of drying gas comprises in said drying drum a second combustion chamber downstream of the second drying chamber and upstream of the unloading head, said system for generating a flow of drying gas comprising at least a second burner having a power less than that of the first burner for generating a second flame in said second combustion chamber and said second flow of drying gas at least in said second drying chamber.

3. The drier according to claim 2, comprising a third burner which generates a third flame in said second combustion chamber, the second and the third burner preferably having a same power, the second flow of drying gas being determined by said second and third flames.

4. The drier according to claim 3, wherein the second and/or the third burner are positioned at said second end of the drying drum.

5. The drier according to claim 2, wherein the ratio between a total length of the first drying chamber and of the first combustion chamber measured along said main axis of extension and a total length of the second drying chamber and of the second combustion chamber measured along said main axis of extension is between 1.5 and 2.5.

6. The drier according to claim 2, wherein the ratio between a length of the second drying chamber measured along said main axis of extension and a length of the second combustion chamber measured along said main axis of extension is between 1 and 4.

7. The drier according to claim 2, wherein said second burner has a power of between 0.5 MW and 4 MW.

8. The drier according to claim 1, wherein said system for generating a flow of drying gas comprises a hot air generator in communication with said second drying chamber for feeding in said second drying chamber said second flow of drying gas.

9. The drier according to claim 1, wherein the first burner comprises a feed duct extending from said unloading head to said first combustion chamber inside said drying drum for feeding a fuel to said first flame in said first combustion chamber, said drier comprising a tubular protection for said feed duct, said feed duct being inserted in said tubular protection.

10. The drier according to claim 9, wherein said tubular protection is fixed to said drying drum.

11. The drier according to claim 1, wherein said feed system comprises a comb-type blade unit supported on an inner surface of the drying drum at said second drying chamber.

12. The drier according to claim 2, wherein said feed system comprises a blade unit for retaining the mixture supported by the inner surface of the drying drum at said second combustion chamber.

13. The drier according to claim 1, wherein said first burner has a power of between 9 MW and 30 MW.

14. A method for drying a virgin inert lithic material and a recycled bituminous material, comprising
introducing the virgin inert lithic material into a drier comprising a drying drum;
heating the virgin inert lithic material with a first flow of drying gas having a first temperature and generated by a first flame;
mixing the heated virgin inert lithic material with the recycled bituminous material, obtaining a mixture;
heating said mixture with a second flow of drying gas having a second temperature less than said first temperature;
unloading the mixture heated by said drying drum.

15. The drying method according to claim 14, comprising generating the second flow of drying gas with at least a second flame in a second combustion chamber in the drying drum.

16. The drying method according to claim 14, comprising generating the second flow of drying gas with a hot air generator and introducing the second flow of drying gas into the drying drum.

17. The drying method according claim 14, wherein the drier is a drier for industrial plants of bituminous macadams.
